(19) United States
(12) Patent Application Publication
(10) Pub. No.: US 2012/0221675 A1
(43) Pub. Date: Aug. 30, 2012

(54) SYSTEM AND METHOD FOR INFERRING USER INTENT WITHIN A NETWORK RESOURCE

(75) Inventor: Derek Ball, Corte Madera, CA (US)

(73) Assignee: Tynt Multimedia Inc., Calgary (CA)

(21) Appl. No.: 13/155,385

(22) Filed: Jun. 8, 2011

Related U.S. Application Data
(60) Provisional application No. 61/352,547, filed on Jun. 8, 2010.

(51) Int. Cl. G06F 15/16

(52) U.S. Cl. 709/217

(57) ABSTRACT

The present invention provides for a novel method and system for improving a user experience when accessing a network resource comprising execution of a software application operating within the software environment of a viewing program operating on a user computer, said viewing program capable of displaying resources available in a network (a “network resource”), said software application identifying an implicit user interaction within said network resource, wherein an implicit user interaction within said network resource causes the software application to provide elements subject to the implicit user interaction as an input value for a software application operable on the user computer or on a computer in network communication with said user computer.

### CROSS-REFERENCE TO RELATED APPLICATIONS

The present Application claims priority from U.S. Provisional Patent Application No. 61/352,547 filed Jun. 8, 2010, which application is expressly incorporated by reference herein for all purposes.

### FIELD OF THE INVENTION

The present invention pertains to the field of data transfer between computer resources communicating by means of a network.

### BACKGROUND OF THE INVENTION

All of the publications, patents and patent applications cited within this application are herein incorporated by reference in their entirety to the same extent as if the disclosure of each individual publication, patent application or patent was specifically and individually indicated to be incorporated by reference in its entirety.

In recent years the popularity of computers, and the communication networks established between these computers, have increased dramatically. Such communications networks allow computer users, either in a business, government or personal setting, to communicate with each other, either through a centralized communication point, through a plurality of distributed and redundant communication points, or directly. This allows exchange of information between the computers on the communication network, using a common communication protocol between them. It is common for corporations or business to establish a common communications network between their computers, otherwise referred to as “intranets”, in which the communication network has limited or no access to unauthorized persons and/or computers. It is common for intranets to be protected by security systems, such as firewalls, which prevent access by unauthorized users of the communications network, the computers communicating through it, and the information contained within these computers.

The term “Internet” has been adopted to describe the publicly available network which has nearly worldwide coverage, and to which most personal computers have access. The pervasive nature of the Internet, combined with the lower cost and increased performance of personal computers, has led to it being a popular source of information. Systems are available which provide an individual with the ability to search for information or resources within the Internet. By way of non-limiting example, systems exist which allow a user to search for information stored on other Internet computers (servers), thus providing generalized access to these resources.

Computers communicate within a network using a common set of standards for exchanging data. One common example is the Transmission Control Protocol/Internet Protocol (TCP/IP) suite. To initiate communications within the communication network, a user (client) may contact another computer on the network (server) and request information or a resource. This is facilitated by various software and hardware systems generally available. A user can access resources within the Internet by being directed through software (e.g., by clicking a hyperlink), by entering a Universal Resource Locator (URL), etc.

A popular protocol for organizing and sharing information on the Internet via the client/server model is known as the HyperText Transfer Protocol (HTTP), and is more commonly referred to in a general sense as the World Wide Web (the web). Generally, the web links information by associating items of interest through the use of HyperText Markup Language (HTML) files, which reside on servers and usually are transferred to clients via HTTP. A user of the web may traverse it by receiving and viewing an HTML file (or just an image, video, etc.), which may contain within it information or embedded images, but which also may contain information on how to acquire further resources from the web, by, for example, incorporating URLs within the file. This information may be displayed to a user as a combination of text and media (for example images, sound, video) and generally is referred to as a “page” or “web page.” Generally, the user uses a client, called a web browser, to interact with the web and the various files found on it (e.g., HTML, audio and video files, etc.). The browser may be implemented through execution of a program operating on a computer, such as a personal computer, cellular telephone or other mobile device.

There is a desire for publishers of content within a web page to improve the user experience within the page, as improved user experience may lead to more frequent user access of the content within the web page, or collection of web pages under a publisher control. As much of the content being generated and presented on web pages is supported, at least partially, through the display of advertising within or in association with the web page, more frequent user access of the web page, or increased user access in general to the web page, can lead to increased display of the advertising therefore increasing revenue. Therefore, improvements to the user experience within the web page, or even through use of a particular network resource display program (including, but not limited to an internet browser) or functionality applicable within the network resource display program; is advantageous.

Many of the computers used today are capable of multi-tasking, and further provide a variety of user interfaces for controlling multiple application programs or system functions simultaneously operating in the computer environment. Personal Computers (“PC”) are particularly commonplace, operating with an operating system (“OS”) capable of multi-tasking such as Microsoft Windows™ or Apple Computer's MacOS™, or LINUX™ Smaller computing platforms such as held-held computers, personal digital assistants (“PDA”), and advanced wireless telephones may run operating systems capable of multitasking as well. As the state of the art advances, there is an increased frequency of users accessing network resources in general, and web pages in particular, using network resource display programs operating on cellular or mobile devices; in addition to PC, PDA and hand-held computers.

The prior art has implemented functionality within a network resource display program, or a network resource, which can improve the user experience or increase user efficiency by enabling certain user actions when interacting with content displayed as part of a network resource. For example, the creation of a highlight or hyperlink for email addresses within an email program, or an email address within the content of a network resource selection of which results in the execution of an email sending program using the email address in the sending field; or a telephone number displayed as part of a network resource displayed by a network resource display program which is highlighted or otherwise hyperlinked so as to execute a calling function within the computing device using the phone number as part of the sending function; or encoding content within a network resource using a markup language, such as the HTML phrasing of “mailto:[user_name]@[domain_name]”. Such implementations in the prior art have been executed by means of software installed within the computing device which detects certain content and then enables functionality within the computing device specific for that content, for example a number with a number of contiguous digits and format consistent with display of a phone number.

### SUMMARY OF THE INVENTION

The present art has suffered from implementation of user functionality within network resources using software forming part of the core functionality of the network resource viewing program, rather than having the functionality implemented through the network resource itself. Therefore the art is in need of a system and method for improving the user experience within a network resource, as implemented by the publisher of the network resource. As well, the present art has suffered from an inability to monitor and interpose functionally to improve the user experience within a network, based upon user interactions with a network resource, without modifying the network resource viewing program or installing software applications resident outside the network resource viewing program.

In one aspect, the present invention provides a method for improving a user experience when accessing a network resource comprising execution of a software application operating within the software environment of a viewing program operating on a user computer, said viewing program capable of displaying resources available in a network (a “network resource”), said software application identifying an implicit user interaction within said network resource, wherein an implicit user interaction within said network resource causes the software application to provide elements subject to the implicit user interaction as an input value for a software application operable on the user computer or on a computer in network communication with said user computer. In a further embodiment, said software application operating within the software environment of a viewing program operating on a user computer, is provided as a result of accessing of said network resource. In a further embodiment the occurrence of an implicit user interaction and the elements within a network resource subject to said implicit user interaction are communicated to a computer within the network other than said user computer.

In another aspect, the present invention provides a system for improving a user experience when accessing a network resource comprising

A first computer in electronic communication with a network;

A second computer in electronic communication with a network;

Wherein said network resource resides on said first computer;

Wherein said network resource is received by said second computer and communicated to a user of said second computer by a viewing program;

Wherein said network resource causes said viewing program to access and execute a software application operating within the environment of said viewing program, which identifies an implicit user interaction with elements of the network resource;

Wherein an implicit user interaction within said network resource causes the software application to provide elements subject to the implicit user interaction as an input value for a software application operable on the user computer or on a computer in network communication with said user computer. In a further embodiment, said software application operating within the software environment of a viewing program operating on a user computer, is provided as a result of accessing of said network resource. In a further embodiment the occurrence of an implicit user interaction and the elements within a network resource subject to said implicit user interaction are communicated to a computer within the network other than said second computer.

### BRIEF DESCRIPTION OF THE FIGURES

FIG. 1 shows a schematic of the communications flow for a user computer running user interaction detection client software, a RUII server and a network resource (for example, a web page) wherein the user computer is accessing a network resource via a network; and

FIG. 2 shows an alternative means of delivering user interaction detection software to the user computer.

### DETAILED DESCRIPTION OF THE PRESENT INVENTION

Embodiments of the present invention provide methods and systems for improving a user experience when accessing network resources available in an electronic network which then provides information to a web publisher, web site administrator or web site manager as to particular content it may present to a user so as to prevent the user from navigating to an alternative web site or network resource.

As used herein, “computer” means a machine having a processor, a memory, and an operating system, capable of interaction with a user or other computer, and shall include without limitation desktop computers, notebook computers, tablet computers, personal digital assistants (PDAs), servers, handheld computers, and mobile or cellular phones capable of satisfying the requirements of the present definition and similar devices.

Though the present invention is explicitly contemplated not to be limited to any particular programming language, the JavaScript™ programming language is highly prevalent in many commercially available Internet browsers; and therefore represents a preferred implementation of the present invention. In a preferred embodiment of the present invention:
1. Software code is communicated proximate in time, or concurrent with, the communication to a second computer of a network resource located on a first computer, by way of non-limiting example a web page; said code containing at least the functions contemplated by the present invention, said network resource comprising digital content.
2. The code is executed proximate in time to the network resource display on said first computer using a program capable of viewing a network resource, such as a web browser, resulting in a implicit user interaction detection program operating on said first computer capable of interacting with the program capable of viewing a network resource, said implicit user interaction detection program capable of detecting certain actions by a user within at least the program capable of viewing a network resource such as the copying of elements within the network resource, printing of the network resource, selecting elements within a network resource, or copying the URL of the network resource (“implicit user interaction”).
3. When an implicit user interaction is undertaken by the user (by way of non-limiting example, a “copy event”) the implicit user interaction detection program causes elements selected subject to an implicit user interaction to be used as an input value for a software application operable on the user computer or on a computer in network communication with said user computer
4. The implicit interaction detection program optionally may report the implicit user interactions to at least one other computer in network communication with the second computer, the implicit user interaction information stored in a database for analysis, such implicit user interaction information comprising what the content subject to the implicit user interaction was, the URL of the original article, the IP address/geographic location of the network viewing program, or other information generally known in the art as useful for identifying relevance of information to a user.

User Experience.

The following is a non-limiting example of the user experience contemplated by the present invention, for a first user accessing a network resource using a network, such as an Internet; a second user; and a network resource administrator, such as a website administrator, who receives information on the content viewed and/or copied by the first user.

With respect to a copy-event, a first user:

1. User is viewing a network resource, such as a web page, using a network resource viewing program, such as a web browser, and decides to copy content from the web page, which includes within it, for example, a phone number.

2. The user selects, by way of non-limiting example, [control C] or Apple C or right clicks and selects the ‘copy’ command, or chooses Copy from the main menu.

3. The implicit user interaction detection software detects that a copy event has been undertaken, and that from the format of the content subject to copying is likely a phone number; using means known in the art and by way of non-limiting example, including no text characters, being primarily numerical, containing a number of digits within an expected range for phone numbers in a particular geographic region.

4. The implicit user interaction detection program, through the network resource viewing program makes a call to launch, external to the network resource viewing program, a computer application capable of making telephonic connections; using the telephone number contained within the copied content as an input value for such a connection. The application capable of making telephonic connections may be selected from a preferred list of programs maintained by the operating system of the computer, or may be an application of the network resource provider's, its agent's or appointee's election. By way of non-limiting example the computer application may communicate using Voice over Internet Protocol (VoIP), an analog telephone line or a cellular data connection.

It is contemplated by the present invention that there are a large variety of computer applications that may be accessed using the content subject to an implicit user interaction as an input value. It will be obvious to one skilled in the art that various elements within content subject to an implicit user interaction can be used as input, including addresses, telephone numbers, email addresses, global positioning coordinates, product identifiers (such as an ISBN or a UPC).

Though there are still network resources made available through an Internet for the benefit of users, the provision of many network resources are supported in whole or in part through revenue generated by presenting advertising in conjunction with the network

Though the present invention is not limited to implementation with a particular network resource implicit user interaction detection system (or as used herein, a “user interaction detection system” or “detection system”), it is contemplated that, in one embodiment, the detection system capable of identifying and communicating implicit user interactions with a network resource will maintain the occurrence of, content of, or particular terms contained within any text elements subject to an implicit user interaction as part of the user interaction detection (Relevant User Interaction Information or “RUII”) separate from the user computer, with at least one computer acting as a centralized server.

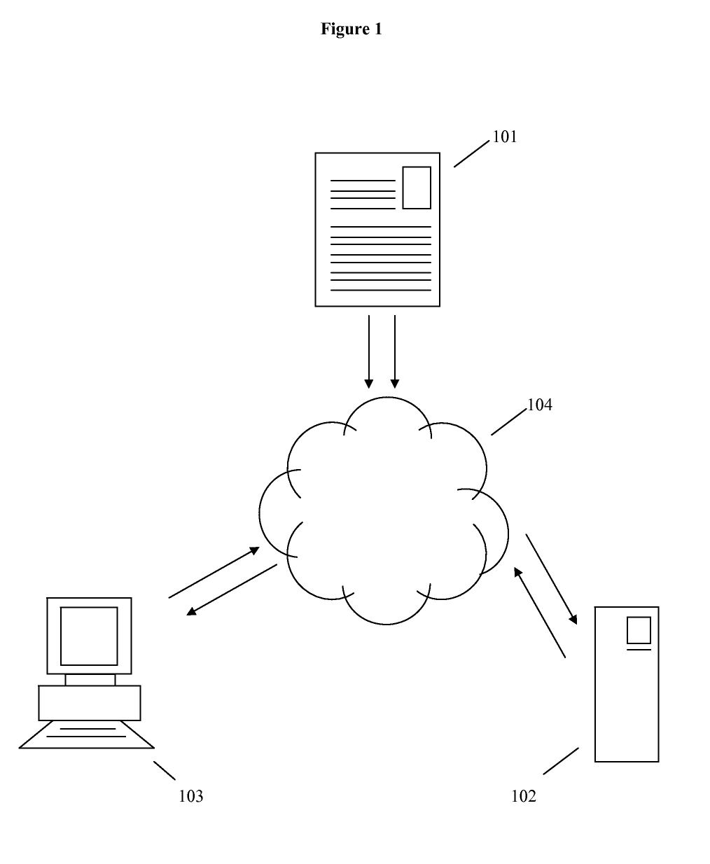

FIG. 1 shows a schematic of the relationship between user computer 103 containing user interaction detection client software, and RUII server 102, wherein a portion of a network resource 101 (e.g., a web page) is subject to a user interaction by the user on user computer 103. It is explicitly contemplated that user interaction may be with a variety of network resources, including but not limited to application specific documents, video content, audio content or databases. The communication between user computer 101, RUII server 102 and network resource 101 may be through a network 104 (e.g., the Internet). In the user interaction detection system contemplated by the present invention, the RUII server 102 communicates with user computer 103 through a client program within user computer 103, where the client program is in network communication with RUII server 102.

It is contemplated that the user interaction detection software may be resident on the user computer, operating either in conjunction with a program or in an environment within a program capable of accessing and displaying network resources and interpreting and effecting computer-readable instructions, including, but not limited to instructions written in Java®, JavaScript, or programming instruction languages particular to a certain web browser, etc. Installation of the user interaction detection software may be by a user such that the software is normally resident upon the computer and is available to the user upon each use of the software capable of accessing or displaying network resources (e.g., a web browser).

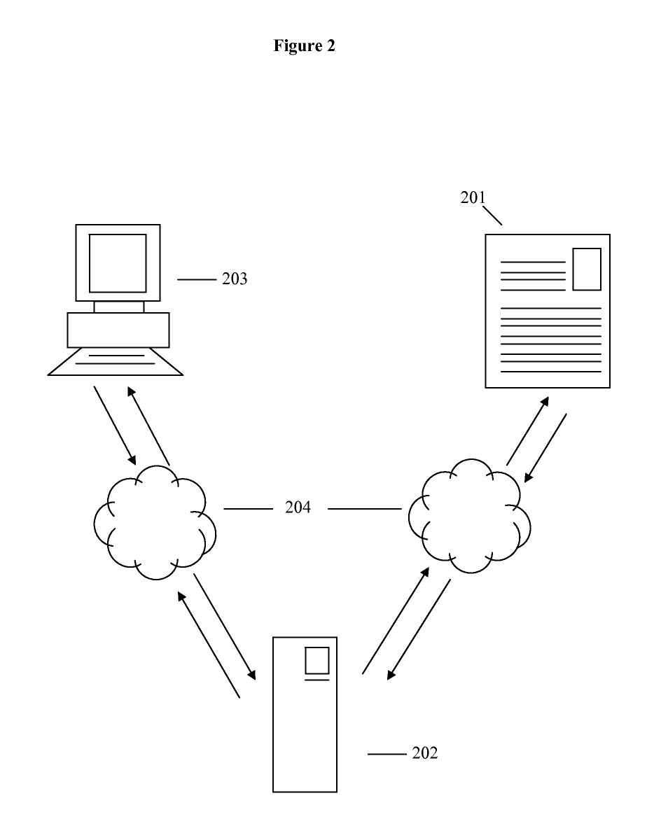

Alternatively, the user interaction detection software may be delivered by means of a network proxy, as depicted in FIG. 2. In this instance, the user interaction detection client software may run within the network browser environment (e.g., via JavaScript), and may be loaded on a per-page basis using a proxy server. In this embodiment, user computer 203 may seek access to network resource 201, wherein the access to network resource 201 is routed through proxy server 202, with proxy server 202 accessing network resource 201. User computer 203, network resource 201 and proxy server 202 all may be in network communication through means of a common network 204 (e.g., the Internet). Network resource 201 may be obtained by proxy server 202 and passed on to user computer 203, together with computer software code capable of interpretation and operation within the user computer 203. The software code when executed implements the processes and functions described and contemplated as the present invention, specifically the detection of user interactions with a network resource and communication of RUII as more fully described herein.

Generally, proxy server 202 only communicates user interaction detection software code prior to, or following, transmission of the originally requested network resource 201. The user interaction detection software then may be executed within the program operating on user computer 203 that is responsible for the accessing and display of network resource 201. It is contemplated that the instructions for the launching of programs external to the network resource viewing program may be provided contemporaneous to the accessing of the network resource by the network resource viewing program or contemporaneous to the implicit user interaction undertaken; and that this information may be provided by the RUII, a proxy server, or alternatively a third computer in network communication with the user computer.

The various systems, modules, etc. described herein may each include a storage component for storing machine-readable instructions for performing the various processes as described and illustrated. The storage component may be any type of machine-readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer-readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

While particular embodiments of the present invention have been described in the foregoing, it is to be understood that other embodiments are possible within the scope of the invention and are intended to be included herein. It will be clear to a person skilled in the art that modifications of and adjustments to this invention, not shown, are possible without departing from the spirit of the invention as demonstrated through the exemplary embodiments. The invention is therefore to be considered limited solely by the scope of the appended claims.

What is claimed is:

1. A system for improving a user experience when accessing a network resource comprising
A first computer in electronic communication with a network;
A second computer in electronic communication with a network;
Wherein said network resource resides on said first computer;
Wherein said network resource is received by said second computer and communicated to a user of said second computer by a viewing program;
Wherein said network resource causes said viewing program to access and execute a software application which identifies a user interaction with elements of the network resource; and
Wherein an implicit user interaction within said network resource causes the software application to provide elements subject to the implicit user interaction as an input value for a software application operable on the user computer or on a computer in network communication with said user computer.
